(19) United States
(12) Patent Application Publication
(10) Pub. No.: US 2012/0105928 A1
(43) Pub. Date: May 3, 2012

(54) SECURITY ELEMENT COMPRISING BASIC REFLECTIVE STRUCTURES

(75) Inventors: Michel Camus, Rives Sur Fure (FR); Stephane Mallol, Provins (FR)

(73) Assignee: ARJOWIGGINS SECURITY, Paris (FR)

(21) Appl. No.: 13/262,562

(22) PCT Filed: Mar. 30, 2010
(86) PCT No.: PCT/IB2010/051382

§ 371 Date: Dec. 23, 2011

(30) Foreign Application Priority Data
Mar. 30, 2009 (FR) 0951980

(51) Int. Cl. B44F 1/02; G02B 27/10; G03H 1/00; G02B 5/08; G02B 5/10

(52) U.S. Cl. 359/2; 359/850; 359/883; 359/627

(57) ABSTRACT

Security element comprising:
an adhesive,
a reflecting optical structure comprising at least one elementary reflecting optical structure having a non-plane reflecting surface giving an image of a pattern in at least one direction of observation of the security element, or comprising at least two elementary reflecting optical structures (9a, 9b) of different types, in particular at least one of which is designed to create a luminous dot which is the image of a luminous source for observation of the security element.

The present invention relates to security elements, in particular those intended to be introduced into security documents.

The expression “security document” designates a means of payment, such as a banknote, a check or a restaurant voucher, an identity document, such as an identity card, a visa, a passport or a driver's license, a lottery ticket, a transport pass or else an entry ticket to cultural or sports events.

When the security element is a security thread and the object intended to receive the security element is a piece of paper, it may be necessary to improve the adhesion of the security element, by using an adhesive covering the two opposite main faces of the security element.

It is known to make security elements with lenticular arrays associated with specific imprints, so as to produce motion effects. The company SECURENCY markets some under the MOTION® brand.

Such security elements utilize an optical structure, a face of which is exposed to the air, so that the difference between the refractive indices of the air and of the material of the structure produces the sought-after refraction of the light rays.

However, these security elements may not be coated with an adhesive with a view to improving the adhesion of the security element within the paper, since the presence of the adhesive attenuates or indeed removes the optical effect, rendering the optical structure inoperative.

The adhesion of the security element may be improved by exposure to a plasma treatment. However, such a treatment is relatively tricky and expensive to implement.

Moreover, diverse other optical structures are known through the publications U.S. Pat. No. 3,241,429, U.S. Pat. No. 3,154,872, U.S. Pat. No. 3,576,089, U.S. Pat. No. 4,645,301, U.S. Pat. No. 4,892,336, WO 94/27254, U.S. Pat. No. 6,856,462, US 2005/184504, U.S. Pat. No. 5,708,871, WO 2005/052650, WO 2005/058610, US 2005/150964 and WO 2007/020048.

Application EP 1 879 057 and patent U.S. Pat. No. 6,200,666 describe retro-reflecting products, such as license plates or signposts, comprising glass balls making it possible to return the light in the direction of the incoming luminous flux.

A need exists to benefit from security elements comprising an optical structure capable of producing optical effects able to contribute to the authentication or the identification of an object, and whose possible incorporation into an object such as a piece of paper can be done relatively conveniently, in particular by virtue of an adhesive.

The subject of the invention is, according to one of its aspects, a security element comprising:
preferably an adhesive,
a reflecting optical structure. comprising at least one elementary reflecting optical structure having a non-plane reflecting surface giving an image of a pattern in at least one direction of observation of the security element, or comprising at least two elementary reflecting optical structures preferably of different types, in particular at least one of which is designed to create a luminous dot which is the image of a luminous source for observation of the security element.

The security element can comprise elementary reflecting optical structures of two different types, the elementary optical reflecting structures of a type being arranged in the form of at least one pattern, in particular alphanumeric or graphical.

Some elementary reflecting optical structures can have a reflecting surface of spherical shape and others of polyhedral, in particular pyramidal, shape with optionally truncated apex.

The elementary reflecting optical structures can exhibit different sizes or shapes, so as to produce image points of a luminous source at different distances, for example.

The reflecting optical structure, and in particular said at least one elementary reflecting optical structure, may be devoid of a reflecting material, for example such as glass halls. In particular, the reflecting optical structure can correspond to an optical structure to the non-plane face of which has been applied a reflecting layer.

The luminous observation source is for example the sun or an electric lamp, in particular a source whose incident rays are parallel or substantially parallel.

The adhesive, when present, facilitates the integration of the security element into the associated article. The reflecting optical structure can comprise non-plane, for example concave or convex, elementary reflecting surfaces, of which a smaller dimension is for example greater than or equal to 20 μm, for example of the order of 30 μm.

The subject of the invention is further, according to another of its aspects, a security element comprising:
a pattern,
an elementary reflecting optical structure, for example a non-plane mirror, giving an image of the pattern, at least in a direction of observation of the security element, and
advantageously, an adhesive.

According to the shape of the elementary reflecting optical structure and the positioning of the pattern with respect to this elementary reflecting optical structure, it is possible to obtain for example a magnified or reduced image of the pattern. The security element can thus be configured to obtain an, uptight or inverted, magnified image of the pattern, in application of the laws of geometric optics.

It is in particular beneficial to obtain a magnified image of the pattern, since this can facilitate observation with the naked eye of a pattern of small dimension.

Whether or not patterns are present, the reflecting optical structure can comprise a concave, convex or Fresnel lens, a lenticular array or else a resin or varnish imprint, for example cross-linkable by ultraviolet rays. The reflecting optical structure can consist of elementary reflecting optical structures, in particular of mirrors disposed according to a regular array, in one or more directions.

The reflecting surface of the optical structure may be made by metallization of a non-plane surface, thereby making it possible to benefit from a continuous reflecting surface, whereas the embossing of a film of a transparent substrate covered on a face by a metal layer would be liable to break the surface of the metal and to lead to the formation of unsightly cracks and/or possibly rendering the optical structure partially inoperative.

The aforementioned mirrors can in particular be formed by the metallization of a lenticular array, a non-plane face of the array being preferably metallized after the manufacture of this array, so as to avoid breaking the metal layer, as explained hereinabove. The mirror or mirrors may be of various types, for example concave, convex, cylindrical, parabolic, spherical or aspherical. Within the array, all the mirrors may be identical or otherwise.

The mirrors can also be obtained by making a Fresnel lens receiving a metallization.

In exemplary implementations of the invention, the mirror or mirrors are concave toward the associated pattern or patterns so as to produce a magnified image of the associated pattern or patterns, and to make it possible to more easily observe the pattern or patterns, despite their small size.

Whether or not patterns are present, the optical structure, in particular the elementary reflecting optical structure or structures, may or may not be situated entirely on one and the same side of a transparent substrate, for example a film of a transparent thermoplastic material, for example polyester. For example, the aforementioned lenticular array may be formed on this substrate, in the same material or otherwise, by being transferred thereto or otherwise. The lenticular array may be made by printing or embossing. The thickness of the substrate is for example between 5 and 100 μm preferably 20 and 30 μm. The substrate can exhibit a constant thickness. The thickness of the substrate can optionally be chosen as a function of the optical structure, for example as a function of the focal length of the mirror, so as to have the sought-after optical effect, as detailed further on.

A pattern associated with the optical structure may be formed on a face of the substrate, in particular by printing, for example printing by a micro-lithography or copper-plate printing method. The pattern can comprise a hologram or other diffraction structure.

The aforementioned lenticular array may be made in such a way that the pattern associated with a mirror is situated between the substrate and the mirror. In this case, the thickness of the substrate need not substantially modify the visual rendition obtained.

The lenticular array can cover a face of the substrate and the pattern or patterns may be formed on the latter on the opposite face. In this case, the choice of the thickness of the substrate makes it possible to move the pattern closer to or further from the mirror, and can make it possible to adapt the distance of the pattern from the mirror as a function of the focal length of the latter.

Independently or otherwise of the presence of one or more patterns, the lenticular array can comprise an array of spherical lenses that are for example concave toward the substrate. In exemplary implementations of the invention, the radius at the apex of a mirror, in particular when the latter is concave toward the associated pattern, can be between 30 and 45 μm. The distance between the apex of the mirror and the adjacent face of the substrate is for example between 10 and 20 μm, being equal to for example between 14 and 16 μm. The pattern associated with the mirror may be situated entirely in the concavity of the mirror. The diameter of the mirror, at the level of its face adjacent to the substrate, is for example between 50 and 70 μm, being equal to for example between 58 and 62 μm.

As mentioned above, the security element may be covered, on its two exterior faces, with an adhesive, making it possible to improve its adhesion within the object in which the security element is introduced, for example a paper fibrous base. The aforementioned substrate can in particular be covered, on its face opposite from the mirror(s), with an adhesive, advantageously transparent, that is heat-sealable. This adhesive may be colorless or colored. The non-plane reflecting surface of the reflecting optical structure can also be covered with an adhesive.

The aforementioned lenticular array may be metallized by a vacuum metallization technique, the metal used being for example aluminum.

The invention is further concerned with an object, in particular a security document, incorporating a security element such as defined above. Such a security document can comprise a paper fibrous base and the security element exhibits at least one visually accessible portion, for example extends as windows in this fibrous base. The security element can for example be a security thread incorporated as window(s) into the security document. The presence of an adhesive covering the two faces of such a security thread, and in particular at the level of the “bridges” (zones where the security thread is covered by fibers of the fibrous base), can make it possible to improve its adhesion within the fibrous base.

The security element may be intended to be observed from a single face of the document, the mirror or mirrors or other elementary reflecting structures being formed on the side of the substrate opposite from the face turned toward the observer. As a variant, the security element can comprise, over one portion of its length, mirrors turned toward one of the faces of the substrate, and over another portion of its length, mirrors turned toward the opposite face of the substrate, so as to allow the observation of one or more patterns by reflection of their image on the reflecting surface of the corresponding mirror or mirrors, independently of the security element's observation face. Other combinations of optical structures are conceivable, in particular the combination of concave and convex spherical mirrors.

The thickness of metallization defining the reflecting surface of the mirror may be sufficient to render the mirror opaque. As a variant, the thickness is sufficiently fine to accord the mirror a semi-reflecting character. If appropriate, the metal layer can comprise partial demetallizations, for example obtained by carrying out the metallization through a mask.

The reflecting effect can further be obtained by applying a layer of high refractive index. In this case, the reflecting structure need not comprise any metallization. Layers of high refractive index are composed of compounds of high refractive index (HRI) for example such as zinc sulfide. These compounds are in particular used to make holograms.

The subject of the invention is further, according to another of its aspects, a method for manufacturing a security element, in which:
a pattern is optionally made,
at least one base optical structure is made, for example an array of elementary base optical structures, optionally associated with the pattern and,
a non-plane surface of said base optical structure or of said array is metallized so as to form a reflecting structure, for example a reflecting structure giving an image of a luminous observation source or of the possible pattern, in particular a ma need image of the latter, a reflecting surface of the reflecting structure being for example concave toward the possible pattern.

The metallization can be done by a vacuum metallization technique.

The formation of the base optical structure, for example of the lens, can be done for example by printing using flexography, ink jet, offset or by silk-screen printing, for example with a dot of ink of a transparent polymer cross-linkable under UV, or by hot embossing of a thermoplastic support with a lens-shaped etched metal die, among other possibilities.

The formation of the base optical structure, for example of the lens, may or may not be done on the same side of a substrate as the possible pattern, with registration or otherwise of the base optical structure with respect to the pattern. In the case of registration, the pattern is for example centered on the optical axis of the base optical structure.

Preferably, a lenticular array comprising a plurality of identical lenses is made, and is metallized so as to form an array of non-plane mirrors constituting as many elementary reflecting structures.

The security element can take the form of a security thread. Such a thread is for example coated on its two main faces with an adhesive. The security thread may be coated with an adhesive on its face comprising the reflecting optical structure.

The security element may be intended to be incorporated into the bulk or as window(s) in a security document.

The security element may be flexible.

The security element, in particular in the form of a security thread, can have a width of greater than or equal to 4 mm, better 5 mm, better still 6 mm, for example of between 6 and 8 mm, better between 6 and 10 mm. The security element can in particular have a width of less than or equal to 8 mm, better 10 mm.

The security element, in particular in the form of a security thread, can have a thickness of between 5 and 100 μm, better between 20 and 30 μm.

The subject of the invention is further a method for authenticating or identifying an object, in which the image, for example of a possible pattern, returned by the reflecting structure, in particular by a mirror, of a security element such as defined hereinabove is observed, and an item of information relating to the identity or the authenticity of the object is determined at least on the basis of this observation.

The aforementioned pattern may be a printing of a light color ink, for example white, or colored.

The invention will be better understood on reading the detailed description which follows, of nonlimiting exemplary implementations thereof, as well as on examining the appended drawing in which:

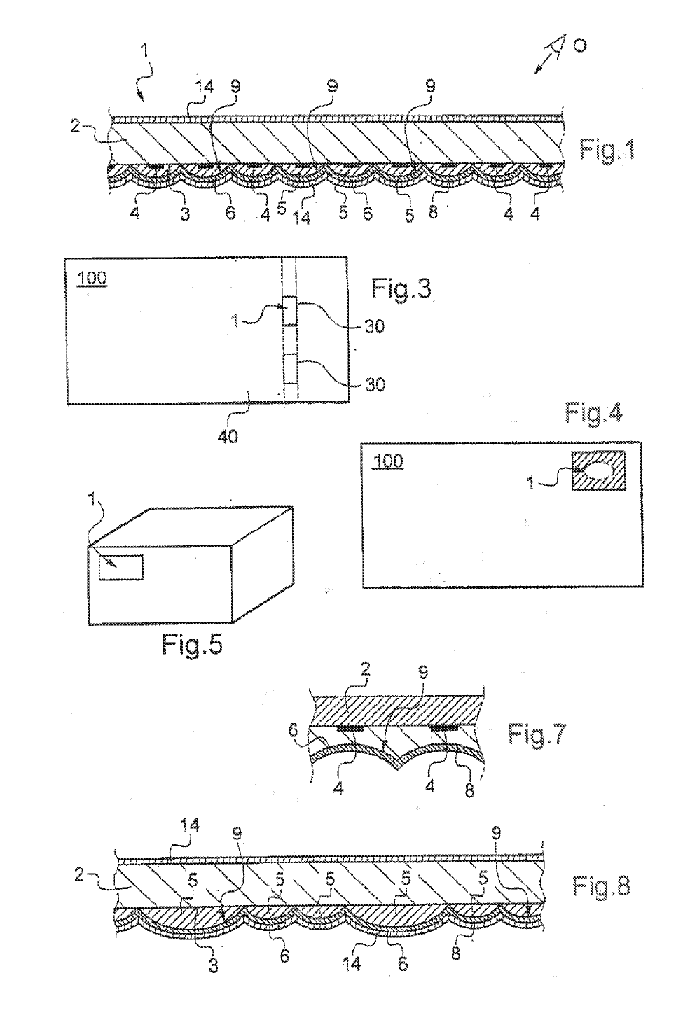

FIG. 1 represents in transverse section an exemplary embodiment of a security element according to the invention,

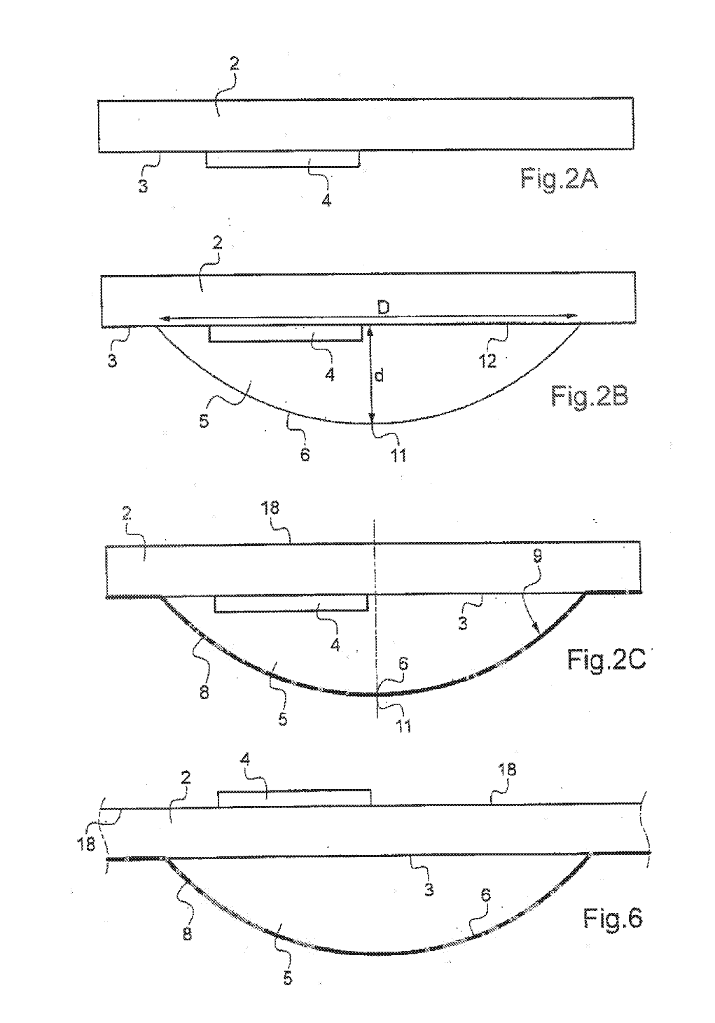

FIGS. 2A to 2C illustrate steps in the making of the security element of FIG. 1,

FIGS. 3 to 5 represent examples of objects comprising a security element according to the invention,

FIGS. 6 to 8 illustrate variant embodiments of security elements made in accordance with the invention,

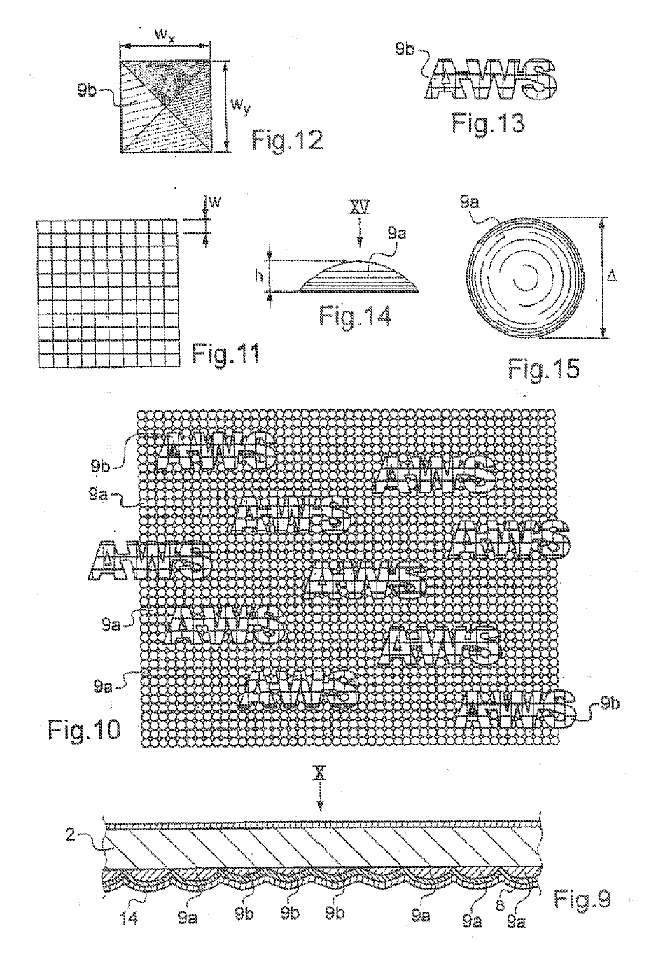

FIG. 9 is a view analogous to FIG. 8 of a variant embodiment,

FIG. 10 is a view from above along X of FIG. 9,

FIG. 11 illustrates a mesh according to which certain elementary reflecting structures may be disposed,

FIG. 12 represents an exemplary elementary reflecting structure,

FIG. 13 represents an exemplary pattern that may be made with the elementary reflecting structures of FIG. 12,

FIG. 14 represents another exemplary elementary reflecting structure,

FIG. 15 represents the elementary reflecting structure of FIG. 14, along XV.

The security element 1 represented in FIG. 1 comprises a substrate 2, a main face 3 of which is covered by one or more patterns 4, for example patterns formed by micro-printing, in particular by a micro-lithography or copper-plate printing technique. The patterns 4 may be printed with a white ink.

The substrate 2 is for example a transparent film of synthetic material, for example a thermoplastic material, in particular polyester.

The substrate 2 carries a reflecting optical structure comprising an array of lenses 5, one of which appears in FIGS. 2A to 2C, these lenses 5 exhibiting a face 6, on the side opposite from the substrate 2, which is non-plane, for example substantially in the shape of a spherical cap, as illustrated.

This face 6 is, in accordance with an aspect of the invention, covered by a reflecting overlay 8, so as to form a non-plane mirror 9 constituting an elementary reflecting structure.

To make the security element 1 represented in FIG. 1, it is possible to begin by overlaying the substrate 2 with the pattern 4, as illustrated in FIG. 2A.

Thereafter, the lenticular array may be formed by covering the pattern 4, as illustrated in FIG. 2B. The formation of the lenticular array may or may not be performed in a manner that is registered with respect to the pattern 4.

The lenses 5 can for example be formed by a technique of printing, for example flexography, ink jet, offset or silk-screen printing, of ink dots of a transparent polymer ink, which may be cross-linkable under UV.

The formation of the lenses can further be done by hot embossing of the substrate 2 with an etched metal die in the form of a lenticular array.

Thereafter, the non-plane surface of the lenticular array is metallized, so as to form the mirrors, as is illustrated in FIG. 2C. The metal is for example aluminum.

It is seen in FIGS. 2B and 2C that a pattern 4 may be situated in the concavity of the corresponding mirror.

The material from which the lens 5 is made being transparent, the mirror 9 can provide an image of the pattern 4 to an observer 0 observing the security element 1 from the side of the opposite face of the substrate 2 from the mirror 9.

In the example considered, the mirror 9 exhibits a concave reflecting face and the distance d between the face 3 of the substrate 2 and the bottom 11 (also called the apex) of the concavity of the mirror 9 is for example 15 μm, for a diameter D at the interface 12 with the substrate 2 of about 60 μm.

Thus, the radius of curvature of the mirror 9 may be about 37.5 μm and the focal length of the mirror is then 18.8 μm. It follows from this that the mirror 9 provides the observer 0 with a magnified image of the pattern 4.

The pattern 4 is for example an imprint 20 μm wide. The substrate is for example 23 μm thick.

In the example of FIG. 1, it is possible to obtain an upright virtual image that is larger than the pattern 4, the latter being situated between the focus and the apex 11 of the concave mirror.

Whatever the reflecting optical structure, the security element 1 may be covered on its exterior faces with a transparent adhesive 14, at least on the observation side. In particular, said adhesive may be a heat-activatable adhesive, in particular such as a heat-sealable coating or a heat-sealable varnish. Such adhesives are particularly advantageous when they are implemented in methods operating at high temperatures, in particular with drying operations commonly used in the field of paper making. As examples of adhesives, in particular of heat-sealable varnishes, mention may be made of an ultraviolet (UV) cross-linkable agent, an adhesive to be irradiated, a pressure sensitive adhesive (PSA), a varnish with a solvent base, of the polyester type for example, an adhesive in the aqueous phase, etc. As adhesive in the aqueous phase mention may be made in particular of those known under the following brands: Mowilith DC (aqueous dispersion of vinyl acetate homopolymer with particles of size ranging from 0.3 μm to 2 μm and glass transition temperature Tg of about 38° C., and with dry content of solid matter between 55 and 57%) and Vinamul 3265 from the company CELANESE; DH9004, DH9017, DH9044 and DL5001 from the company COLLANO; Primal NWI 845, Primal LC40, Primal P308M and Primal EP6000 from the company ROHM & HAAS; 006SDW078-2 from the company BASF.

The presence on the security element 1, on either side of the substrate 2 and of the reflecting coating layer 8, of these layers 14 intended to improve the adhesion of the security element 1 within the object in which it is intended to be inserted, does not affect the vision of the pattern reflected by the mirror.

In a variant embodiment, use is made of a substrate 2, which may be less thick, for example 6 μm in thickness, the pattern 4 being formed by printing on the opposite face 18 of the substrate 2 from the mirror 9. In this case, the pattern 4 may be situated at a greater distance from the apex of the mirror than its focus, and an inverted real image which is larger than the pattern is obtained.

In another variant embodiment, the mirror 9 is made with a reflecting surface that is convex toward the pattern, as illustrated in FIG. 7, thereby producing a smaller image.

If appropriate, another optical device, for example an enlarging lens, for example of the Fresnel lens type, may be associated with a reflecting mirror so as to further magnify the image produced by the mirror.

In another variant embodiment illustrated in FIG. 8, the image seen by the observer does not originate from a printed pattern but consists of the set of luminous dots created at the focal length of each mirror. The mirrors 9 can, as illustrated, be of different sizes so as to create luminous dots for example of different size or situated at various distances from the observer's eye.

Represented in FIGS. 9 to 15 is a variant embodiment in which the image seen by the observer is due to the way in which the light is reflected by a plurality of elementary reflecting structures, of at least two different types.

In FIG. 9, it is seen that the transparent substrate 2 can comprise on a face a plurality of elementary reflecting structures 9a and 9b, of different respective shapes, covered by a layer 8 making it possible to create a reflecting surface, for example a metal layer. The reflecting elementary structures 9a are for example portions of a sphere as illustrated in FIGS. 14 and 15, with a height h of for example between 10 and 20 μm, for example of the order of 15 μm, and a diameter Δ of for example between 20 and 40 μm, for example of the order of 30 μm.

The reflecting elementary structures 9b are for example mirrors of pyramidal Shape or in the form. of a frustum of a pyramid, for example with square base of side Wₓ or W_{y}, for example of between 20 and 40 μm, for example of the order of 30 μm, the larger dimension Wₓ or W_{y} being for example equal to the diameter Δ at the reflecting base of the elementary structures 9a.

The elementary reflecting structures 9b are for example disposed like the mesh cells of an array, as represented in FIG. 11, of spacing W for example equal to Δ, for example of the order of 30 μm, The reflecting elementary structures 9b may he arranged according to patterns, as illustrated in FIGS. 13 and 10. The reflecting elementary structures 9a and 9b may be formed in diverse ways, for example by relief printing followed by metallization of these reliefs.

The security element 1 can take the form of a security thread, for example intended to be incorporated as windows into a piece of paper 40, as illustrated in FIG. 3.

In this case, the security element 1 extends for example between two opposite edges of the paper. The security element may be flush with the surface of the paper via its exterior face situated on the opposite side from the mirror(s), at the level of a window 30.

As a variant, as illustrated in FIG. 4, the security element 1 is applied in patch form.

The security element 1 can further be integrated into an item of packaging, as illustrated in FIG. 5, or into a label.

Of course, the invention is not limited to the examples illustrated.

It is in particular possible to make the patterns other than by printing, for example by demetallization of a metal having a different color from that forming the reflecting surface of the mirror, laser etching, or to use a thermochromic or photochromic, fluorescent or phosphorescent luminescent ink to make the pattern by printing.

The metal layers may be replaced with layers of a material of high refractive index.

The expression “comprising a” must be understood as being synonymous with “comprising at least one”, unless specified to the contrary.

1. A security element comprising:
an adhesive covering at least a portion of the security element; and
a reflecting optical structure reflecting an image of a pattern in at least one direction of observation of the security element, the reflecting optical structure comprising at least one of:
at least one elementary reflecting optical structure having a non-planar reflecting surface and
at least two elementary reflecting optical structures of different types.

2. The security element as claimed in claim 1, wherein the elementary reflecting optical structure comprises at least two elementary reflecting optical structures of two different types arranged in at least one pattern.

3. The security element as claimed in claim 2, wherein the at least two elementary reflecting optical structures comprise an elementary reflecting optical structure having a reflecting surface of spherical shape and an elementary reflecting optical structure having a reflecting surface of polyhedral shape.

4. A security element comprising:
a reflecting optical structure comprising at least two elementary reflecting optical structures configured to create luminous dots which are the image of a luminous source for observation of the security element, and
an adhesive covering at least a portion of the security element.

5. A security element comprising:
a pattern;
an elementary reflecting optical structure reflecting an image of the pattern at least in a direction of observation of the security element; and
an adhesive covering at least a portion of the security element.

6. The security element as claimed in claim 5, wherein the security element is configured to reflect an upright or inverted magnified image of the pattern.

7. The security element as claimed in claim 5, wherein the pattern is a printed pattern.

8. The security element as claimed in claim 5, wherein the pattern comprising comprises at least one hologram.

9. The security element as claimed in claim 5, further comprising a plurality of elementary reflecting optical structures.

10. The security element as claimed in claim 9, wherein the elementary reflecting optical structures comprise a metallized lenticular array.

11. The security element as claimed in claim 1, wherein the at least one elementary reflecting optical structure or at least two elementary reflecting optical structures comprise one or more mirrors that are concave toward the pattern.

12. The security element as claimed in claim 5, further comprising a transparent substrate, wherein the reflecting optical structure is situated on one side of the transparent substrate.

13. The security element as claimed in claim 12, wherein the pattern is disposed on the substrate.

14. The security element as claimed in claim 12, wherein the pattern is disposed between the substrate and the reflecting optical structure.

15. The security element as claimed in claim 10, further comprising a substrate, wherein the lenticular array is disposed on a first side of the substrate and the pattern is disposed on a second side of the substrate opposite to the first side.

16. The security element as claimed in claim 10, further comprising a substrate, wherein the lenticular array comprises an array of spherical lenses that are concave toward the substrate.

17. The security element as claimed in claim 9, wherein the elementary reflecting optical structures comprise mirrors having a radius of curvature at an apex of a mirror ranging from 30 μm to 45 μm.

18. The security element as claimed in claim 1, wherein the adhesive is configured to bond the security element to an object having a paper fibrous base.

19. The security element as claimed in claim 1, wherein the security element is a security thread.

20. The security element as claimed in claim 1, wherein the security element has a thickness ranging from 5 μm to 100 μm.

21. The security element as claimed in claim 1, wherein the security element has a width ranging from 6 mm to 10 mm.

22. An object configured for verification of an authenticity of the object comprising incorporating the security element of claim 1 incorporated in the object.

23. The object as claimed in claim 1, wherein the object is a security document and the security element is incorporated into the bulk of the object or as one or more windows in the security document.

24. The security element as claimed in claim 1, wherein the image is chosen from an image from a pattern overlayed on a substrate and luminous dots from a luminous source.

25. The security element as claimed in claim 2, wherein the at least two elementary optical reflecting structures of differing types are arranged in at least one of an alphanumeric and graphical pattern.

26. The security element as claimed in claim 3, wherein the polyhedral shape is chosen from a pyramidal shape and a pyramidal shape with a truncated apex.

27. The security element as claimed in claim 1, wherein the printed pattern is a micro-lithographic printed pattern or a copper plate printed pattern.
